(19) United States
(12) Patent Application Publication
(10) Pub. No.: US 2012/0250874 A1
(43) Pub. Date: Oct. 4, 2012

(54) AUDIO DEVICE AND METHOD FOR AUDIO OUTPUTTING

(75) Inventor: HUA-LIN LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/205,634

(22) Filed: Aug. 9, 2011

(30) Foreign Application Priority Data
Apr. 1, 2011 (CN) 201110082264.2

(51) Int. Cl. H04R 1/10

(52) U.S. Cl. 381/74

(57) ABSTRACT

An audio device includes a headphone jack to receive a headphone plug, an audio output unit connected to the headphone jack, a detecting unit, and a control unit. The detecting unit detects insertion of a headphone plug into the headphone jack when playing an audio file. The control unit directly decreases an output power of the output unit to a first preset value within a preset period in response to the detected insertion of a headphone plug into the headphone jack, and gradually increases the output power of the output unit to a second preset value after the preset period is elapsed. A related method is also provided.

### CROSS-REFERENCE TO RELATED APPLICATIONS

Related subject matter is disclosed in co-pending U.S. patents application with an Attorney Docket Number US38365 and a title of AUDIO DEVICE AND METHOD FOR AUDIO OUTPUTTING, which have the same assignees as the current application and were concurrently filed.

### BACKGROUND

1. Technical Field

The present disclosure relates to audio devices and methods for audio outputting of the audio devices.

2. Description of the Related Art

When a headphone is plugged into a headphone jack of an audio device when the audio device is already on and playing, the audio device may output an unpleasant noise.

Therefore, there is room for improvement within the art.

### BRIEF DESCRIPTION OF THE DRAWINGS

The components in the drawings are not necessarily drawn to scale, the emphasis instead being placed upon clearly illustrating the principles of an audio device and a method for audio outputting. Moreover, in the drawings, like reference numerals designate corresponding parts throughout the several views.

FIG. 1 is a block diagram of an audio device in accordance with an exemplary embodiment.

FIG. 2 is a flowchart of a method for audio outputting of the audio device in FIG. 1 in accordance with an exemplary embodiment.

### DETAILED DESCRIPTION

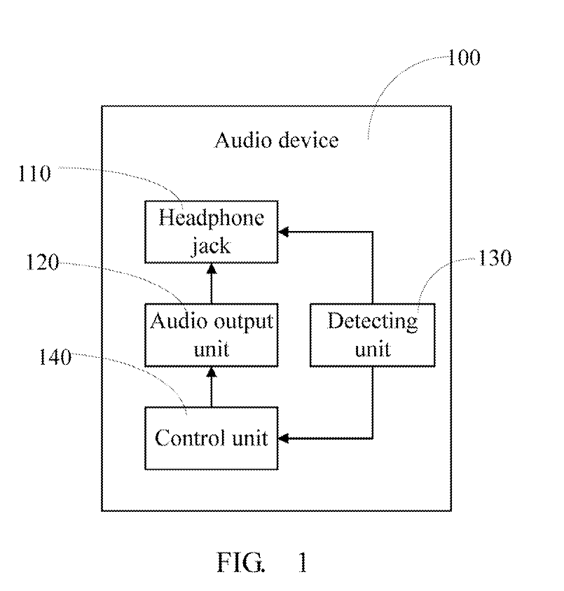

Referring to FIG. 1, an audio device 100 includes a headphone jack 110 for receiving a headphone plug, an audio output unit 120 connected to the headphone jack 110, a control unit 140 for controlling output power of the audio output unit 120, and a detecting unit 130 connected to the headphone jack 110 and the control unit 140. The detecting unit 130 is configured for detecting insertion of a headphone plug into the headphone jack 110 when playing an audio file. The control unit 140 directly decreases an output power of the output unit 120 to a first preset value within a preset period in response to the detected insertion of a headphone plug into the headphone jack 110. With such configuration, when a headphone is plugged into the headphone jack 110, the volume of audio output from the audio output unit 120 decreases to avoid generating any unpleasant noise. The control unit 140 gradually increases the output power to a second preset value after the preset period is elapsed. The first preset value is less than the second preset value. In the embodiment, the second preset value is equal to an original value of the output power of the output unit 120 before a headphone plug is inserted into the headphone jack 110. The control unit 140 gradually increases the output power to the second preset value at a preset rate.

In the embodiment, when the detecting unit 130 detects voltage at the headphone jack 110 changes from a high level (such as 5V) to a low level (such as 1V), the detecting unit 130 determines the insertion of a headphone plug from the headphone jack 110. When the detecting unit 130 detects voltage at the headphone jack 110 changes from a low level (such as 1V) to a high level (such as 5V), the detecting unit 130 determines the removal of the headphone plug from the headphone jack 110. The control unit 140 decreases the output power of the output unit 120 to the first preset within the preset time period when the detecting unit 130 determines that a headphone is being plugged into the headphone jack 110, and increases the output power of the output unit 120 to the second preset value when the preset time period elapses. The first preset value may be greater than zero or equal to zero. If the output power of the audio output unit 120 becomes zero, the audio output unit 120 in fact has no output and is mute.

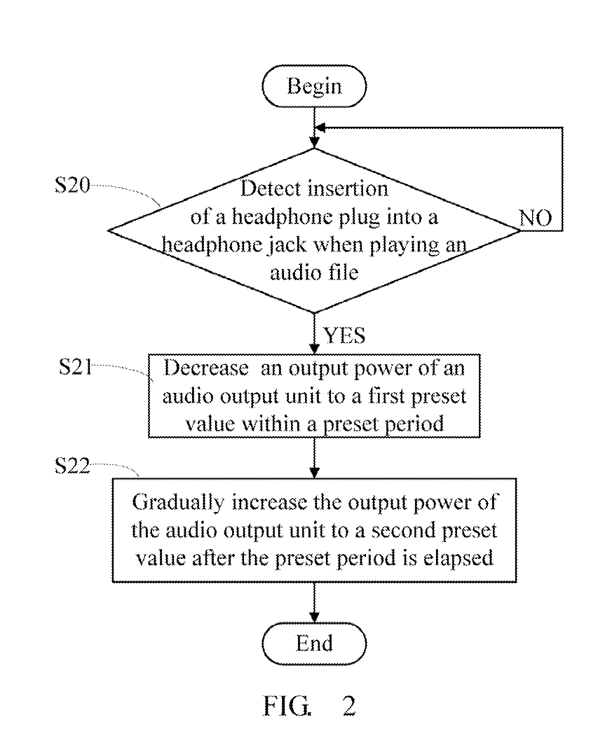

FIG. 2 is a flowchart of outputting audio signals from an audio device in accordance with an exemplary embodiment.

In step S20, the detecting unit 130 detects insertion of a headphone plug into the headphone jack 110 of the audio device 100 when playing an audio file. If the a detecting unit 130 detects insertion of a headphone plug into the headphone jack 110 of the audio device 100, the procedure goes to step S21, otherwise, the procedure repeats step S20.

In this embodiment, when the detecting unit 130 detects signals from the headphone jack 110 changes from a high level such as 5V to a low level such as 1V, the detecting unit 130 determines the insertion of a headphone plug.

In step S21, the control unit 140 decreases the output power of the output unit 120 to a first preset value within the preset time period in response to the detected insertion of the headphone plug into the headphone jack 110. The preset value may be greater than zero or equal to zero.

In step S22, the control unit 140 gradually increases the output power of the output unit 120 to a second preset value after the preset period is elapsed.

In the embodiment, the second preset value is equal to an initial value of the output power of the output unit 120 before a headphone is plugged into the headphone jack 110. The control unit 140 gradually increases the output power to be the second preset value at a preset rate.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An audio device comprising:
a headphone jack for receiving a headphone plug;
an audio output unit connected to the headphone jack;
a detecting unit for detecting insertion of a headphone plug into the headphone jack when playing an audio file; and
a control unit for directly decreasing an output power of the audio output unit to a first preset value within a preset period in response to the detected insertion of a headphone plug into the headphone jack, and gradually increasing the output power of the output unit to a second preset value after the preset period is elapsed.

2. The audio device as recited in claim 1, wherein the second preset value is greater than the first preset value.

3. The audio device as recited in claim 1, wherein the second preset value is equal to an original value before a headphone plug is inserted into the headphone jack.

4. The audio device as recited in claim 1, wherein the first preset value is equal to zero.

5. The audio device as recited in claim 1, wherein the first preset value is greater than zero.

6. The audio device as recited in claim 1, wherein the detecting unit is configured to determine the insertion of a headphone plug by detecting a voltage at the headphone jack changes from a high level to a low level.

7. A method for outputting audio signals from an audio device, the audio device comprising a headphone jack for receiving a headphone plug, the method comprising:
detecting insertion of a headphone plug into a headphone jack of the audio device when playing an audio file;
decreasing an output power of an audio output unit of the audio device to a first preset value within a preset period in response to the detected insertion of the headphone plug into the headphone jack; and
gradually increasing the output power of the audio output unit of the audio device to a second preset value after the preset period is elapsed.

8. The method as recited in claim 7, wherein the second preset value is greater than the first preset value.

9. The method as recited in claim 7, wherein the second preset value is equal to an original value before a headphone is plugged into the headphone jack.

10. The method as recited in claim 7, wherein the first preset value is equal to zero.

11. The method as recited in claim 7, wherein the first preset value is greater than zero.

12. The method as recited in claim 7, wherein the insertion of the headphone plug into the headphone jack is determined by detecting a voltage at the headphone jack changes from a high level to a low level.
